(19) United States
(12) Patent Application Publication
(10) Pub. No.: US 2009/0147779 A1
(43) Pub. Date: Jun. 11, 2009

(54) METHODS, IPTV (INTERNET PROTOCOL TELEVISION) TERMINAL, AND IPTV CONTROL SERVER FOR IPTV BANDWIDTH MANAGEMENT

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/952,660

(22) Filed: Dec. 7, 2007

(51) Int. Cl. H04L 12/56

(52) U.S. Cl. 370/389

(57) ABSTRACT

An IP Television (IPTV) terminal, an IPTV control server, and methods for used therein are provided for delegating the service admission control from the network to the terminals. As an IPTV terminal initiates a new IPTV service (e.g. linear TV, Video-on-Demand), a bandwidth balance available for use by IPTV terminals of the given IPTV subscription is verified locally, and if sufficient bandwidth is found, then the service is allowed and started. The terminal then informs the IPTV control server of the service initiation and a new bandwidth balance is obtained by the server, and sent to all IPTV terminals for the subscription. Next time a new service is initiated by any of the IPTV terminals of the given subscription, that new bandwidth balance is used locally by the terminals, to determine if sufficient bandwidth remains available for using the new service, thus allowing or inhibiting initiation of the service.

### TECHNICAL FIELD

The present invention relates to methods and communication nodes for IPTV (Internet Protocol Television) bandwidth management.

### BACKGROUND

IP (Internet Protocol) multimedia services provide a combination of voice, video, messaging, and data or, alternatively, can support just one service within a given session. By increasing the number of applications and media that it is possible to combine, the number of services offered to the end users can be augmented, thus enriching the inter-personal communication experience. This leads to a new generation of personalized, rich multimedia communication services, including the so-called “Internet Protocol Television (IPTV)” services.

The IP Multimedia Subsystem (IMS) is a technology defined by the Third Generation Partnership Project (3GPP) to provide multimedia services over mobile communication networks. IMS allows mobile networks such as GSM (Global system for mobile communication), GPRS (General Packet Radio Service), UMTS (Universal Mobile Telecommunications System), WLAN (Wireless Local Area Networks), along with fixed line networks to support multimedia services for end-users. IMS is therefore considered as access agnostic. IMS provides key features to enrich the end-user person-to-person communication experience through the use of standardised IMS Service Enablers, which facilitate new person-to-person (client-to-client) communication services as well as person-to-content (client-to-server) services over IP-based networks. IMS makes use of the Session Initiation Protocol (SIP) to set up and control calls or sessions between user terminals (or user terminals and application servers). The Session Description Protocol (SDP), carried by SIP signalling is generally used to describe and negotiate the media components of an IMS session.

SIP is an Internet Engineering Task Force (IETF) protocol that supports the initiation and management of communication sessions. Like other protocols, such as HTTP (Hyper Text Terminal Protocol) or SMTP (Simple Mail Transfer Protocol), SIP works in the application layer of the open system interconnection (OSI) communications model, which is responsible for insuring communication is possible. SIP can establish multimedia sessions or Internet telephony calls and can modify, or terminate them. The protocol can also allow participants to invite each other to unicast or multicast sessions, or establish such sessions without necessarily involving the initiator. Because SIP supports name mapping and redirection services, it makes possible for users to initiate and receive communications and services from end location, and for networks to identify the users wherever they are. Participants to SIP sessions are identified by SIP URLs (Uniform Resource Locators). Requests can be sent through any transport protocols such as, for example UDP (User Datagram Protocol), or TCP (Transfer Control Protocol). SIP determines the end system to be used for the session, the communication media and its parameters, and the called party's desire to engage in a communication and, when these are assured, establishes call parameters at either end of the communication, and handles call transfer and termination. SIP protocol is specified in the IETF's request for comments RCF 3261, which is herein included in its entirety.

Whilst SIP was created as a user-to-user protocol, IMS allows operators and service providers to control user access to services and to charge users accordingly.

The boundaries between the services provided by telecommunication operators, TV operators, and internet service providers are nowadays vanishing, and many of such companies are offering customers three services (so called “triple play”) or more. For telecommunication operators wishing to offer TV services, a popular choice is to utilize the so called IPTV which delivers the TV service over IP via the customer's broadband connection (e.g. ADSL—Asynchronous Digital Subscriber Line, VDSL—Very high bit-rate Digital Subscriber Line, Public Ethernet, etc.).

IPTV has a limited bandwidth at its disposal in the “last mile” to the end-user. The “last mile” typically designates the access network connection between the end-user and the core network, e.g. from the user's XDSL modem or DSLAM (Digital Subscriber Line Access Multiplexer) to the core network, or the air interface access (wireless) from a wireless terminal to the core network. Broadcast content delivery, in which all channels in a TV program package are simultaneously delivered to a Set Top Box (STB), is not suitable for IPTV due to the limited bandwidth in the last mile. For example, xDSL connection bandwidth capacity varies depending on the DSL version used and the length of the “last mile”. ADSL can provide a capacity between 3 to 8 Mbps, whereas ADSL2 promises to deliver up to 25 Mbps downstream. Finally, VSDL data rates are greater than 30 Mbps. However, standard quality MPEG2 (Motion Picture Experts Group 2) TV content requires 2 Mbps per channel, and the delivery of HDTV (High Definition Television) will require 8-10 Mbps per channel. While the new MPEG4 standard attempts to decrease the required bandwidth to half compared to MPEG2 coded content, the available bandwidth in the last mile remains a scarce resource, and thus IPTV solutions must limit the number of TV channels to be delivered simultaneously over the “last mile”.

Existing channel switching solutions are based on the Internet Group Management Protocol (IGMP) augmented with proprietary solutions in some cases in order to speed up signalling. IGMP is an Internet protocol that allows an Internet node (e.g. mobile terminal, computer, server) to report or request a multicast group membership to adjacent routers. Multicasting allows the sending of content to multiple destinations that have identified themselves as interested in receiving the originating server's content. Multicasting can be used for “broadcasting” high-bandwidth programs of streaming media to an audience that has “tuned in” by setting up a multicast group membership.

Reference is now made to FIG. 1 (Prior Art), which is a simplified level nodal operational and signal flow diagram describing an IPTV service communication between an end user and a server using HTTP messages. Shown in FIG. 1, is an IPTV Terminal Function (ITF, also called herein interchangeably IPTV terminal) 101 that communicates via an access node 103 with a user database 106 and an IPTV control server 108. The STB along with a television terminal in a home environment are called ITF, or IPTV terminal. The nature of the access node 103 may vary depending on which access type is used: fixed cupper line, wireless, fibre access etc. For example, an access node can be a DSLAM for fixed cupper line networks. The ITF 101 is typically located in a user's home environment while the IPTV control server 108 is located on the operator's network side.

In FIG. 1, when the ITF 101 is powered on, action 111, an authentication procedure 113 takes place between the ITF 101 and the IPTV control server 108 (note that the HTTP messages between user database 106 and IPTV control server 108, are omitted for simplicity purposes) for the ITF to be granted service by the network. Once successfully authenticated, the ITF 101 sends to the IPTV control server 108 an HTTP request 115 to ask for the provision of, for example, linear TV service. In the context of IPTV, linear TV can be defined as TV programming scheduled by broadcasters and transmitted, channel by channel, to all IPTV users tuned to that channel. On the other hand, Video on Demand (VoD) represents TV content specifically requested by each end users and being transmitted only to the user(s) requesting, at that given time, the particular VoD content. The IPTV Control server 108 performs admission control, such as for example by checking the end user record to ensure that the number of admitted ITFs 101 of the given IPTV subscription has not been exceeded, action 117 (note that the interaction between user database 106 and IPTV control server, are omitted for simplicity purposes). If the number of admitted ITFs is not exceeded, e.g. if the ITF 101 is the first ITF to request network access of a given IPTV subscription that supports a maximum of 2 (two) ITFs to be used concomitantly, then the control server 108 updates the end-user record for that subscription and authorizes the IPTV service for the ITF 101. The IPTV control server 108 responds in action 119 informing that the request is accepted. The ITF 101 receives authorization to watch linear TV programming and then issues, for example, an IGMP Join message (Internet Group Management Protocol) for requesting receipt of the desired TV program, in action 121. Subsequently, the user can watch the requested linear TV channel, action 125.

The above-described prior art IPTV solution has the disadvantage that the bandwidth allocated per service in the last mile is static, i.e. a static amount of bandwidth is reserved for the service regardless if that service uses the allocated bandwidth or not. As a dedicated amount of bandwidth is reserved for the IPTV service, the maximum number of ITFs that can be tuned simultaneously is pre-determined. This is clearly inefficient, as it does not allow the last mile bandwidth to be shared, and may result in premature rejection of other IP service sessions due to unavailability of bandwidth for those services, even if in actual facts there is still available bandwidth in the last mile.

Reference is now made to FIG. 2 (Prior Art), which is a high level nodal operation and signal flow diagram of an IMS-based IPTV network 200, describing an IPTV service communication between an end user and an IPTV control server 211 using SIP messages.

Shown in FIG. 2, is an ITF 201 that communicates via an access node 203 with an IPTV control server 211, in order to deliver TV program data to the ITF 201. The access node 203, may be a DSLAM (Digital Subscriber Line Access Multiplexer) or a base station that connects the ITF to the network, possibly via the Internet (not shown). The IPTV control server 211 has a central coordination role in the network when an IPTV session is set up during signalling e.g. creating a connection to the requested service content (e.g. to a VoD session or Linear TV). The IPTV control server 211 interacts with an HSS (Home Subscriber Service) 207, as well as other databases, if required, in order to get user-related information and the IMS core network 209 for session management and resource admission purposes in the last mile. The RACF (Resource Admission Control Function) 205 has the function of managing the available bandwidth in the last mile and keeps track of bandwidth updates whenever changes affecting the bandwidth are made, for example at the end user side. The HSS 207 stores user subscription information, including but not limited to user services, preferences, location information, etc. The IMS Core 209 includes one or more CSCFs (Call Session Control Function), and is responsible for carrying out the IMS session as such in accordance with applicable 3GPP specifications.

In FIG. 2, when the ITF 201 is powered on, action 214, it performs an IMS registration procedure towards the IMS core 209, action 216, so that the ITF can register with the network, and be authenticated and authorised for network access (note that the SIP messages exchanged in a regular IMS Registration, action 216 procedure between end user and the IMS network, are omitted for simplicity purposes). After successful registration, the IMS core 209 sends in action 218 a third party registration to the IPTV control server 211 to inform the server that the ITF 201 has successfully registered with the IMS network. Thereafter, the ITF 201 retrieves configuration information from the IPTV control server 211 so that it can perform its operation. To that effect, the ITF 201 sends a request through a SIP SUBSCRIBE message, action 222, to the IPTV control server 211 for retrieving the needed configuration information. The IPTV control server 211 returns a 200 OK message to the ITF 201 as acknowledgement, action 224. The IPTV control server 211 then sends a NOTIFY message including pertinent configuration information, action 226, e.g. parameters, services allowed and reasons for denials if applicable, for the ITF 201. The ITF 201 acknowledges receipt of the SIP Notify message with a 200 OK message, action 228 and then initiates an IMS session for linear TV, action 230. Once the IMS session is successfully established, the ITF 201 issues an IGMP JOIN to request the viewing of a given TV channel, action 232. The, the channel's content is being delivered to the ITF 201, action 234.

The existing IMS based IPTV solution described in FIG. 2 also has several disadvantages. The IMS session utilised for watching linear TV content is held for a long period of time simply to be able to reserve the required bandwidth in the last mile. This solution lacks scalability because of the long duration of those broadcast sessions Since IMS sessions are stateful, they consume memory and processing power in the IMS nodes and require continuous refreshing in order to maintain the IMS session state. Finally, both prior art solutions for IPTV admission control are network-based, i.e. it is the network that allows or inhibits the initiation of IPTV services on behalf of the end-user. This creates delays from the end-user's perspective between the moment an IPTV service is requested up to the time when the allowance or rejection from the network is sent back to the terminal, thus diminishing the user's experience.

Accordingly, it should be readily appreciated that in order to overcome the deficiencies and shortcomings of the existing solutions, it would be advantageous to have a solution for providing fast and efficient last mile bandwidth management for IPTV terminals' admission control.

### SUMMARY

According to the present invention, an IP Television (IPTV) terminal, an IPTV control server, and methods for used therein are provided for delegating the service admission control from the network to the terminals. As an IPTV terminal initiates a new IPTV service (e.g. linear TV, Video-on-Demand), a bandwidth balance available for use by IPTV terminals of the given IPTV subscription is verified locally, and if sufficient bandwidth is found, then the service is allowed and started. The terminal then informs the IPTV control server of the service initiation and a new bandwidth balance is obtained by the server, and sent to all IPTV terminals for the subscription. Next time a new service is initiated by any of the IPTV terminals of the given subscription, that new bandwidth balance is used locally by the terminals, to determine if sufficient bandwidth remains available for using the new service, thus allowing or inhibiting initiation of the service.

It is an object of the present invention to provide a method for admission control in an IP Television (IPTV) terminal, the method starting by receiving at the IPTV terminal bandwidth information regarding an available bandwidth related to an IPTV subscription to which the IPTV terminal belongs. Then, it is determined at the IPTV terminal if the available bandwidth is sufficient for carrying out an IPTV service selected at the IPTV terminal, and the IPTV service is initiated when it is determined at the IPTV terminal that sufficient bandwidth is available.

It is another object of the present invention to provide an IPTV terminal that comprises a memory storing bandwidth information regarding an available bandwidth related to an IPTV subscription to which the IPTV terminal belongs, a processing module in communication with the memory that obtains the information regarding the available bandwidth and determines if the available bandwidth is sufficient for carrying out a selected IPTV service, and an IPTV application module adapted to support IPTV services for the IPTV terminal, wherein the IPTV application module initiating the selected IPTV service when the processing module determines that sufficient bandwidth is available.

It is yet a further object of the present invention to provide a method for updating one or more IPTV terminals with bandwidth information, the method starting with the steps of obtaining at an IPTV control server bandwidth information regarding an available bandwidth related to an IPTV subscription to which the one or more IPTV terminals belong. Then, the method allows the transmitting of the bandwidth information t from the IPTV control server to each one of the one or more IPTV terminals.

It is yet another object of the invention to provide an IPTV control server comprising module that obtains bandwidth information regarding an available bandwidth related to an IPTV subscription to which one or more IPTV terminals belong, and subscription database that stores IPTV subscription information including the bandwidth information for the IPTV subscription, wherein the IMS stack transmits to each one of the one or more IPTV terminals the bandwidth information.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior art) is a nodal operation and signal flow diagram illustrative of a known prior art implementation of an IPTV service;

FIG. 2 (Prior art) is another nodal operation and signal flow diagram illustrative of an IMS-based implementation of an IPTV service

FIG. 3 is an exemplary high level nodal operation and signal flow diagram illustrative of a possible implementation of the preferred embodiment of the present invention;

FIG. 4 is a high level block diagram illustrative of an exemplary implementation of the preferred embodiment of the invention in an IPTV terminal; and

FIG. 5 is another high level block diagram illustrative of an exemplary implementation of the preferred embodiment of the invention in an IPTV Control Server.

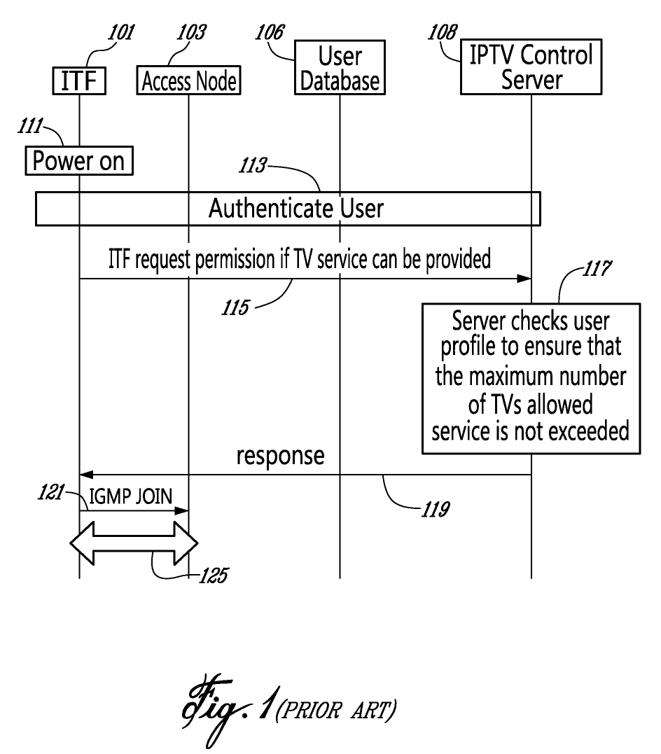

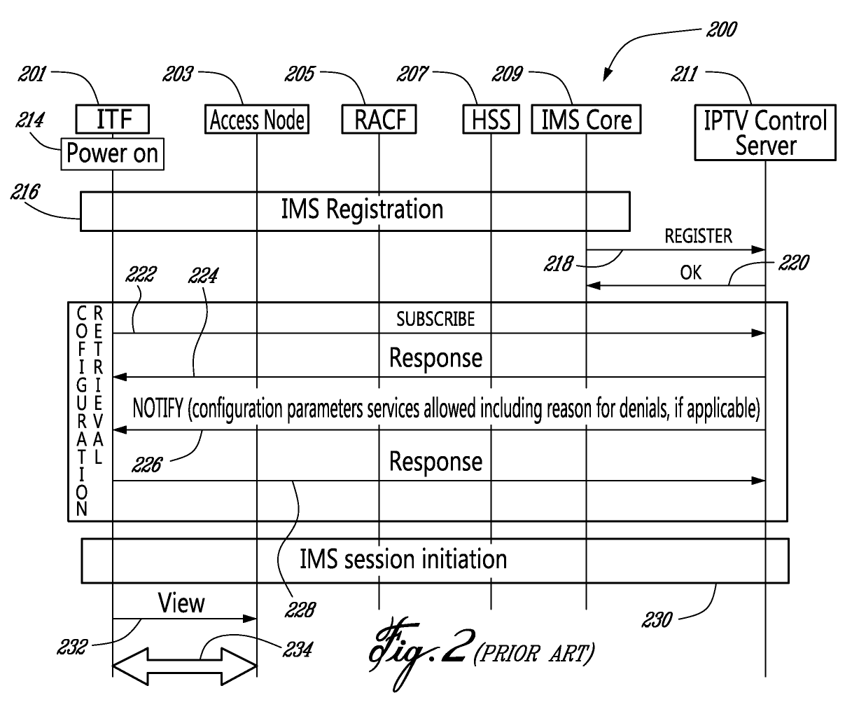

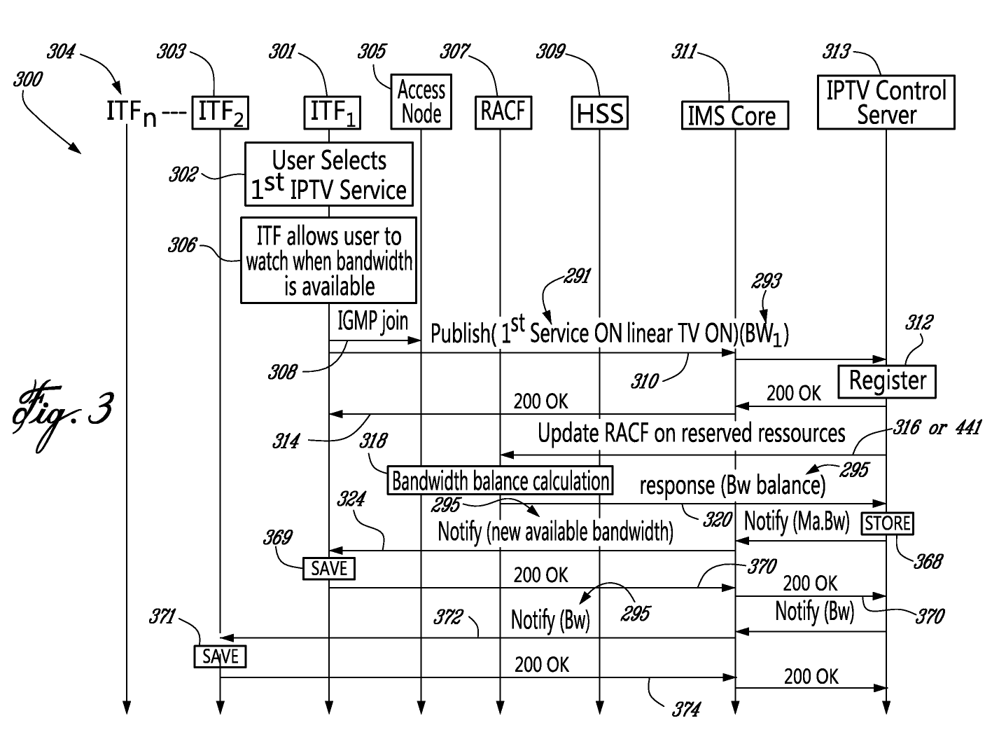

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designed with identical reference numerals throughout the several views.

According to the present invention and its related preferred embodiments, there is provided a method and communication nodes allowing the dynamic and real-time updating of bandwidth status (i.e. the available bandwidth) in the last mile for ITFs of an IPTV subscription. According to the invention, bandwidth status information is distributed dynamically and in real-time to all IPTV terminals (ITFs) of a given IPTV service subscription (which sometimes can correspond to a household, where individuals share the same subscription) so that admission control is “delegated” to these terminals for improving service set up times, user experience, and saving network resources.

According to the invention, various mechanisms, such as SIP NOTIFY messages or a SIP PUBLISH messages, may be used, in order to enable an ITF using one or more given services to communicate to the IPTV control server its IPTV services being used and/or its bandwidth consumption. The IPTV control server uses the information from these messages either to directly update the bandwidth balance in the last mile or to query the RACF to get an update regarding the available bandwidth available in the last mile (access network). Subsequently, the IPTV control server reports that bandwidth information to all ITFs of the subscription. With this information available, the ITFs can perform local admission control when needed, i.e. when a new IPTV service is initiated, and determine whether or not sufficient bandwidth is available to carry out the IPTV service requested by the user.

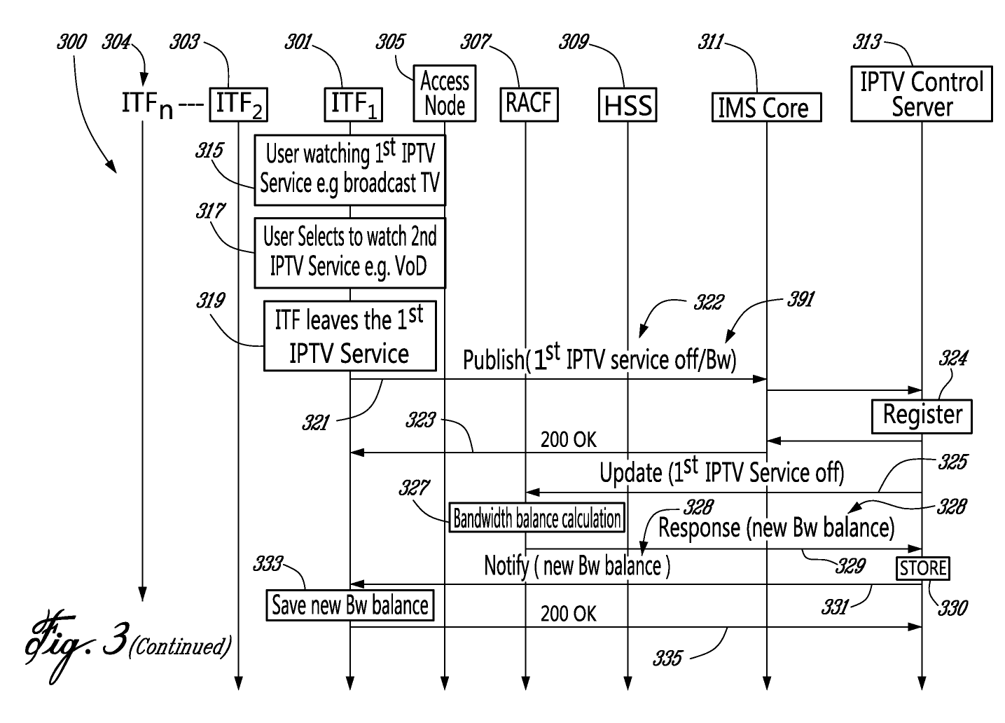

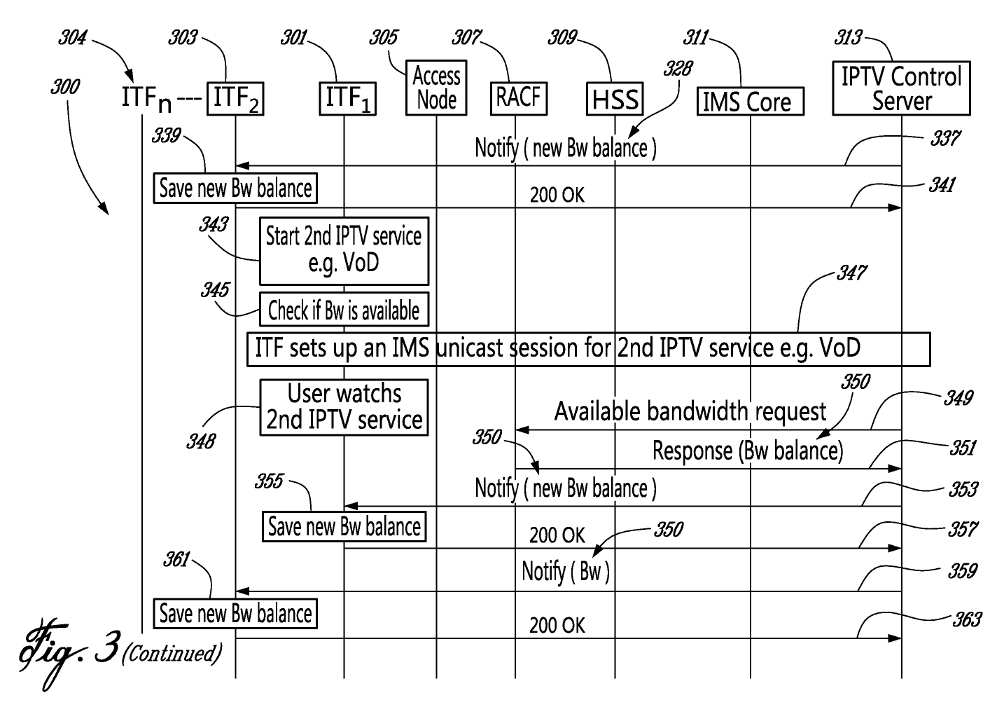

Reference is now made to FIG. 3, which shows an exemplary nodal operation and signal flow diagram of a simplified exemplary IMS network 300 implementing a preferred embodiment of the invention. The IMS network 300 is adapted to provide IPTV service to a number of ITFs, among which only ITF1 301, ITF2 303, until ITFn 304 are shown for simplicity purposes. Such ITFs can be, for example, mobile devices, fixed computers, Set-Top-Boxes, or other electronic devices. ITFs have the function of ensuring IPTV service for end-users, and may be capable of providing other services as well. For example, an ITF may be a mobile device, or located within a mobile device, which can be connected via a wireless network to the Internet, and as such, may be capable of providing voice communications, data communications other than IPTV, Push-To-Talk, or Internet access. The access node 305 connects the ITFs to the network and/or to the Internet, and may be a DSLAM or a base station. The IPTV control server 313 interacts with a Home Subscriber Server (HSS) 309 that stores subscriber data, and with the IMS Core 311. The HSS 309 is typically the database that stores user subscription information, including but not limited to user services, preferences, location information, etc. An RACF 307 has the function of managing the available bandwidth in the last mile, and in the aggregate network, and also performs new bandwidth calculations whenever changes are made at the end user side. The IMS Core 311 includes one or more CSCFs (Call Session Control Function) and is responsible for carrying out IMS sessions in accordance with the 3GPP specifications.

The exemplary scenario illustrated in FIG. 3 starts after the ITF1 301 has registered with the IMS network 300 via, for example, a typical IMS registration procedure, and after it obtained authorization from the IPTV control server 313 to get IPTV service. Such procedures are well known in the art. However, the ITF1 301 may refrain from setting up an IMS session, and can rather directly attempt to request IPTV service without necessarily establishing the IMS session.

In action 302, the ITF1 301 decides to select a first IPTV service to watch, such as for example linear TV programming, action 302. In action 306, the ITF1 301 determines based on bandwidth information it stores if there is sufficient bandwidth available for the 1^{st} IPTV service. If so, the ITF1 301 issues an IGMP Join message to the access node 305 in order to request provision of the service, action 308, by subscribing to the multicast group related to the 1^{st} PTV service. The ITF1 301 then needs to update the network of the fact it is using resources for the receipt of the first IPTV service, and for that purpose sends a SIP PUBLISH message including an indication 291 that the first IPTV service is on, via the IMS Core 311, to the IPTV control server 313, action 310. Alternatively, the SIP PUBLISH message may comprise an indication 293 of the bandwidth required for the use of the 1^{st} IPTV service. In the later case when the SIP PUBLISH message includes the indication 293 of the bandwidth required for the use of the 1^{st} IPTV service, the IPTV control server calculates and registers in action 312 the new bandwidth balance for the ITV subscription. Otherwise, if the SIP PUBLISH message includes only the indication 291 that the first IPTV service is active, the IPTV control server 313 registers that the first IPTV service is on in action 312, and responds with a 200 OK message via the IMS Core 311 to the ITF1 301, action 314. Following that, the IPTV control server 313 may send an update request message to the RACF 307, action 325, the message possibly including the indication 291 that the first IPTV service is on, which instructs the RACF 307 to reserve the necessary resources for the first IPTV service. The RACF 307 calculates and updates its bandwidth resource book for keeping functionality that keeps track of the available bandwidth related to the ITF's subscription in the last mile, action 318. The available bandwidth balance may be calculated by subtracting from the total available bandwidth of that given IPTV subscription the actual, current, bandwidth consumption of every active ITF from the ITFs 301, 303, 304, which belong to the given IPTV subscription. The RACF 307 typically also has information about the bandwidth consumption of the ITFs in relation with other non-IPTV services as well, such as for example when an ITF uses bandwidth resources for services like voice communications or Internet access, and may calculate the bandwidth balance by taking into consideration such other services as well.

The RACF 307 then sends the updated bandwidth balance 295 in a response to the IPTV control server 313, action 320. The IPTV control server 313 receives the message and stores, in action 368, the bandwidth balance 295 that is indicative of the available bandwidth still available for use by the ITFs 301, 303, and 304. Then, the IPTV control server 313 acts to inform all ITFs 301, 303, and 304 of the available bandwidth 295 using, for example, SIP NOTIFY messages, actions 324 and 372. All ITFs 301, 303, 304 that are powered on receive this update (it is assumed that only ITFs 302 and 303 are powered on and thus are receiving the messages), and save the new bandwidth balance 295 in actions 369 and 371 and thereafter send a 200 OK message to the IPTV control server 313, actions 370 and 374, to confirm receipt of the SIP NOTIFY messages.

The purposes of the messages 324 and 372 is to propagate the available bandwidth balance information to the end-user's ITFs, so that the admission control is delegated to the end-user terminals, thus not only rendering the admission decisions faster from the perspective of the end-user but also saving network resources by disallowing services at the ITF level when the required bandwidth is not available in the last mile.

In action 315, the user is currently watching the first IPTV service such as for example watching linear TV programming of a given television station. In such an instance, the ITF1 301 receives TV content transmitted from a content provider server (not shown), which consumes a certain amount of bandwidth (BW=X) in the last mile between the access node 305 and the ITF1 301. At this point, the certain amount of bandwidth (BW=X) used for transmitting the linear TV channel has been authorised and is registered both in the RACF 307 and the IPTV control server 313.

At a later point in time, the user of the ITF1 301 decides to select a second IPTV service to watch, such as for example a Video on Demand (VoD) movie programming, action 317, the second service possibly being in need of a different bandwidth allocation than the first IPTV service. The ITF1 301 then leaves the first IPTV service, action 319, when the user terminates the viewing of the first IPTV service by sending, for example, an IGMP Leave message to the multicast address to which the ITF1 301 is currently tuned. After leaving the first IPTV service, the ITF1 301 needs to update the network of the fact it is no longer using resources for the receipt of the first IPTV service, and for that purpose may send a SIP PUBLISH message including an indication 322 that the first IPTV service is terminated via the IMS Core 311 to the IPTV control server 313, action 321. Alternatively, the SIP PUBLISH message may comprise an indication 391 that a certain amount of bandwidth (e.g. BW=X) is being freed up by the termination of the first IPTV service. The IPTV control server 313 registers that the first IPTV service is terminated, or alternatively registers the amount of the freed up resources (e.g. BW=X), action 324, i.e. when the SIP PUBLISH message comprises the indication 391 of the bandwidth being freed up by the termination of the 1^{st} IPTV service, the IPTV control server may calculate an updated bandwidth balance as part of action 324 by considering the already stored bandwidth balance of the given subscription, and by subtracting from that balance the bandwidth being used for the 1^{st} IPTV service.

Otherwise, if the SIP Publish message only contains the indication 322 that the first IPTV service is terminated, the ITF 1 301 responds with a 200 OK message via IMS Core 311 to the ITF1 301, action 323. Following that, the IPTV control server 313 may send an update request message to the RACF 307, action 325, the message including the indication 322 that the first IPTV service is terminated, which instructs the RACF 307 to release the resources reserved for the first IPTV service. The RACF 307 also calculates and updates its last mile bandwidth resource book keeping functionality that keeps track of the available bandwidth related to the ITF's subscription in the last mile, action 327, by considering the information to the effect that the first IPTV service is now terminated, and then sends the updated bandwidth balance 328 in a response to the IPTV control server 313, action 329. The available bandwidth balance 328 may be calculated using the bandwidth consumption known by the RACF 307 for every active ITF 301, 303, 304 of the given IPTV subscription and then comparing the result with the allowed bandwidth that are stipulated in the subscription, i.e. the difference between the total bandwidth for the subscription and the total consumption by the ITFs 301, 303 gives the available bandwidth balance. Moreover, the RACF 307 may also have information about the bandwidth consumption of the ITFs in relation with non-IPTV services as well, such as for example when an ITF uses bandwidth resources for services like voice communications or Internet access, and may calculate the updated bandwidth balance by taking into consideration such other services as well.

After action 329, the IPTV control server 313 stores, action 330, the updated bandwidth balance 328 that is indicative of the currently available bandwidth allocated for use by the ITFs 301, 303, and 304 of the given IPTV subscription. Then, the IPTV control server 313 acts to inform the ITFs 301, 303, and 304 of the given IPTV subscription of the updated available bandwidth 328 using, for example, SIP NOTIFY messages, actions 331 and 337. All ITFs 301, 303, 304 that are powered on receive the update, and save the new bandwidth balance 328 in actions 333 and 339. Thereafter, each ITF sends a 200 OK message to the IPTV control server 313, action 335 and 341, to confirm receipt of the SIP NOTIFY messages.

The purposes of the messages 331 and 337 is to propagate the available bandwidth balance information to the end-user's ITFs, so that the admission control is delegated to the end-user terminals, thus not only rendering the admission decisions faster from the perspective of the user but also saving network resources by disallowing services at the ITF when the required bandwidth is not available in the last mile.

In action 343, the ITF1 301 instructs the starts of the second IPTV service (e.g. VoD movie programming). The ITF 301 first checks the available bandwidth balance 328, action 345. If there is enough bandwidth available for the requested service, i.e. if the 2^{nd} IPTV service necessitates less bandwidth than what is available, the ITF1 301 pursues by settings up an IMS unicast session for supporting the 2^{nd} IPTV service, action 347 (it is assumed in the presently described exemplary scenario that the 2^{nd} IPTV service is VoD, which requires the setup of an actual IMS unicast session, although such session is not necessarily required in other cases, e.g. when the 2^{nd} IPTV service is linear TV programming). During this session establishment, action 347, the new resources needed for the second IPTV service are calculated and this information is transmitted to the RACF 307 since RACF is involved in the IMS unicast session setup. The RACF 307 also calculates the new available bandwidth balance over the last mile for the concerned IPTV subscription, by taking into account the bandwidth requirements for the 2^{nd} IPTV service.

In action 348, once the IMS unicast session is established, the ITF 1 301 receives the 2^{nd} IPTV service content so the user can watch the programming.

The successful establishment of the IMS Unicast for the 2^{nd} IPTV service triggers the IPTV control server 313 to send a message to the RACF 307 requesting the available bandwidth in the last mile, action 349. The RACF 307 then responds back to the IPTV control server 313 with the updated available bandwidth 350, action 351.

Thereafter, the IPTV control server 313 again propagates to the ITFs of the given subscription the latest available bandwidth. For this purpose, the server 313 sends a SIP NOTIFY message to the ITF1 301 containing new bandwidth balance 350, action 353. The ITF1 301 saves the new bandwidth balance, action 355, and sends a 200 OK to the IPTV control server 313, action 357.

In the same way, ITF2 303 receives a SIP Notify message, action 359, saves the bandwidth balance, action 361, and responds with a 200 OK, actions 363. In this manner, each ITF of the subscription knows, at every moment, the currently available bandwidth balance for ITV service, so that admission control such as in action 345 can be performed at the terminal side when requesting a new IPTV service.

It is to be noted that the same type of admission control analogous to the one performed in action 345 can be done by any other ITF of the same subscription, since each ITF is provided with the same bandwidth balance information. Therefore, although the presently described exemplary scenario has been exemplified using actions done only in the ITF 1 301, it is to be understood that such action can be performed by other ITFs of the same subscription. For example, the 2^{nd} IPTV service can be started in action 343 by the ITF 2 303, and in such instance the actions 345, 347, and 348 involve the ITF 2 303.

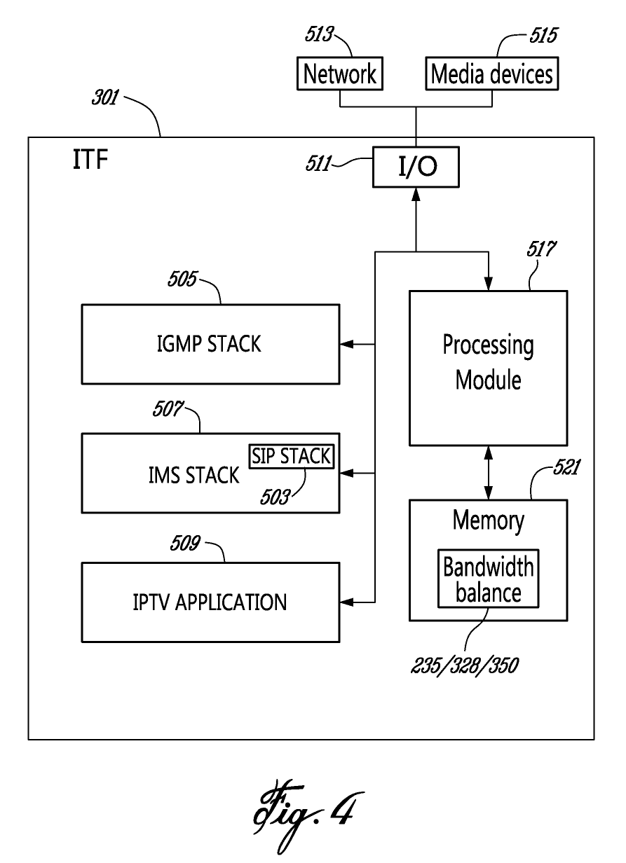

Reference is now made to FIG. 4, which shows an exemplary high level functional block diagram of an ITF node 301 according to the preferred embodiment of the present invention. The ITF node 301 may take various forms, such as for example may comprise a mobile terminal, a PDA, a computer system, an STB, etc. In order to perform its functions, the ITF 301 includes various communication modules that may comprise an IGMP (Internet Group Management Protocol) stack module 505 responsible for joining/leaving multicast addresses, an IMS stack module 507 responsible for setting up and management of IMS sessions, and an IPTV application module 509 responsible for supporting IPTV services. Furthermore, the IMS stack 507 may typically comprise a SIP stack module 503 supporting SIP communications. Other modules may of course be further present in the ITF as well, although not illustrated for simplicity purposes. The ITF 301 further comprises a processing module 517 and memory 521. On the basis of instructions from the IPTV application 509, the processing module 517 receives media from the network and distributes it further to media devices 515, which could be any terminal alike TV screen or PC screen, or a mobile phone. The memory 521 stores the available bandwidth balance 328/350 received in updates from the IPTV control server 313. The ITF node 301 communicates with networks 513 and different media devices via one or more Input/Output (I/O) interfaces 511.

Reference is now being made jointly to FIG. 4, and to FIG. 3, previously described. In action 302, the user selects via the IPTV application module 509 to watch the first IPTV service, and in action 306 a check is performed by the processing module 517 to determine whether or not there is sufficient bandwidth available for the selected service, by accessing the memory 521 and retrieving the bandwidth balance information stored therein. When it is determined that the bandwidth balance is sufficient, the IPTV application module 509 initiates the first IPTV service by sending the IGMP Join message, action 308, so that the ITF 301 can receive the ITPV programming. The IMS stack 507 issues the SIP PUBLISH message in action 310, that is sent via the I/O interface 511 to the IPTV control server 313 to inform of the start of the first IPTV service, and receives back in action 324 the SIP NOTIFY message with the updated bandwidth balance 295, which it saves in action 369 in the memory 521.

When the user is watching the first IPTV Service, action 315, the IPTV application instructs the processing module 517 to send the received TV media via the I/O interface 511 to the media device 515. At a later point in time, the user selects to watch the second IPTV service, action 317, via the same IPTV application 509. The later instructs the IMS stack 507 to issue the SIP PUBLISH message of action 321. The IMS stack 507 then receives the 200 OK message from the network followed by a SIP NOTIFY message comprising the available bandwidth balance in the last mile for the subscription, action 331. The ITF's processing module 517 saves the new bandwidth balance 328 in the memory 521, action 333, and then instructs the IMS Stack 507 to send the 200 OK message to the IPTV control server 313, action 335, FIG. 3, to confirm the receipt of the bandwidth balance. Then, the IPTV application 509 attempts to start the second IPTV service. First, the processing module 517 checks if enough bandwidth is available by accessing the bandwidth balance 328 in the memory 521, action 345. Presuming that enough bandwidth is available, the IMS Stack 507 sets up the IMS unicast session towards the network 513 for the second IPTV service, action 347. TV media is distributed from the network 513 via the processing module 517 to the media device 515. Then, the ITF 301 receives a SIP NOTIFY message via its IMS stack 507 comprising the new available bandwidth balance for the subscription, action 353. The ITF 301 saves the new bandwidth balance 350 in the memory 521, action 355. The ITF 301 then sends a 200 OK message from the IMS Stack 507 to the network 513, action 357.

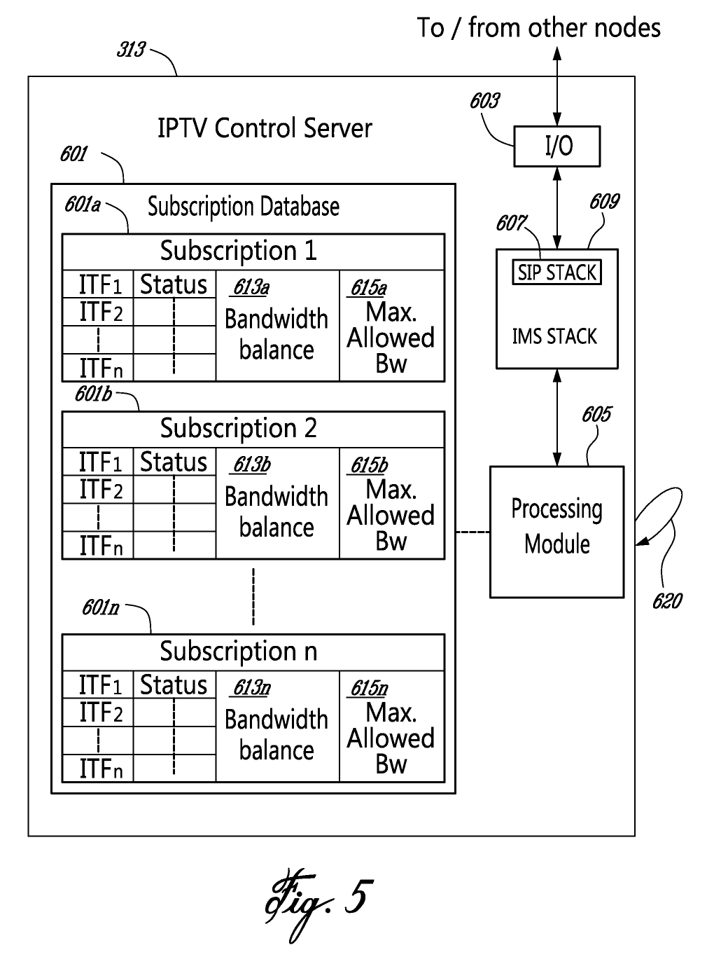

Reference is now made to FIG. 5, which shows an exemplary high level functional block diagram of the IPTV control server 313 according to the preferred embodiment of the present invention. The IPTV control server 313 is responsible for service access and authorizing ITFs to receive IPTV service, for locating content provider servers based on requests from ITFs, and for managing the bandwidth required for IPTV services. It is also responsible for generating the necessary information for billing purposes. The server 313 may contain, or have access to, a subscription database 601 that contains user subscription information for a plurality of IPTV subscriptions 601a to 601n, each one including information regarding, for example, the maximum allowed bandwidth usage 615 for that subscription, the current bandwidth usage 613 for that IPTV subscription, the list of ITFs associated with the IPTV subscriptions, and their current status (e.g. powered on, powered off, etc). The server further comprises an I/O interface 603, a processing module 605, and an IMS stack 609 supporting IMS communications towards different nodes in the network and for setting up and tearing down IMS sessions. Furthermore, the IMS stack 609 typically comprises a SIP STACK module 607 supporting SIP communications.

Reference is now being made jointly to FIG. 5, and to FIG. 3, previously described. In action 310, the ITF1 301 needs to update the IPTV control server 313 of the fact it is using resources for the receipt of the first IPTV service, and for that purpose sends a SIP PUBLISH message including the indication 291 that the first IPTV service is on, via the IMS Core 311 to the IPTV control server 313, action 310. Alternatively, the SIP PUBLISH message may comprise the indication 293 of the bandwidth being used for the 1^{st} IPTV service. In this second case, the processing module 605 may calculate the updated bandwidth balance, action 620, by considering the already stored bandwidth balance 613 of the given subscription, and by subtracting from that balance the bandwidth being used for the 1^{st} IPTV service.

In the first case, when the SIP PUBLISH message includes the indication 291 that the first IPTV service is on, the IPTV control server 313 registers that the first IPTV service is on, action 312, and responds with a 200 OK message via IMS Core 311 to the ITF1 301, action 314. Following that, the IMS stack 609 of the IPTV control server 313 may send an update request message to the RACF 307, action 325, the message possibly including the indication 291 that the first IPTV service is on, which instructs the RACF 307 to reserve the necessary resources for the first IPTV service. The RACF 307 views the message as a request to update the bandwidth balance (available bandwidth), and thus calculates and updates its bandwidth resource book for keeping functionality that keeps track of the available bandwidth related to the ITF's subscription in the last mile, action 318 and then sends the updated bandwidth balance 295 in a response to the IPTV control server 313, action 320.

Responsive to action 320, the IPTV control server 313 stores in the subscription database 601, action 368, the bandwidth balance 295 that is indicative of the available bandwidth still available for use by the ITFs 301, 303, and 304. Then, the IPTV control server 313, via its IMS stack 609, acts to inform all ITFs 301, 303, and 304 of the subscription of the available bandwidth 295 using, for example, SIP NOTIFY messages, actions 324 and 372.

The purpose of the messages 324 and 372 is to propagate the available bandwidth balance information to the end-user's ITFs, so that the admission control is delegated to the end-user terminals, thus not only rendering the admission decisions faster from the perspective of the user but also saving network resources by disallowing services at the ITF when the required bandwidth is not available in the last mile.

When a user leaves the first IPTV service, in action 319, the IMS stack 609 of the IPTV control server 313 receives a SIP PUBLISH message indicating that the service is off, action 321. The IMS stack 609 of the IPTV control server 313 sends a bandwidth update request to the RACF 307, action 325 and receives back a response with the updated bandwidth balance information for the subscription, action 329, FIG. 3. The received information is stored by the processing module 605 in the IPTV subscription database 601 in the proper subscription, action 330. The IPTV control server 313 then sends a SIP NOTIFY message to all powered on ITFs 301, 303, including updated bandwidth balance information for the subscription, action 331, 337.

In action 347, the IPTV control server 313 receives a request for an IMS session in order to support the second IPTV service. The IMS stack 609 participates in the IMS session set-up, and, following the successful set up of the IMS session, the IMS stack 609 of the IPTV control server 313 sends a request to the RACF 307 for receiving the available bandwidth, action 349. The IPTV server 313 obtains the current bandwidth balance for the subscription 601a in action 351, and the processing module 605 saves the bandwidth balance in the subscription database 601. The IMS stack 609 of the IPTV control server 313 then distributes the updated bandwidth balance for the subscription 601a to all ITFs 301, 303 that belong to the subscription by sending SIP NOTIFY messages in actions 353 and 359.

Therefore, it becomes apparent, that according to the present invention there are provided advantageous methods, an IPTV terminal and an IPTV control server that enable delegation of the admission control to IPTV terminals. Based upon the foregoing, it should now be apparent to those of ordinary skills in the art that the present invention provides an advantageous solution, which offers a simple yet flexible terminal-based admission control for IPTV services. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for admission control in an IP Television (IPTV) terminal, the method comprising the steps of:
a. receiving at the IPTV terminal bandwidth information regarding an available bandwidth related to an IPTV subscription to which the IPTV terminal belongs;
b. determining at the IPTV terminal if the available bandwidth is sufficient for carrying out an IPTV service selected at the IPTV terminal; and
c. initiating the IPTV service when determining at the IPTV terminal that sufficient bandwidth is available.

2. The method of claim 1, wherein the bandwidth information specifies the total available bandwidth in an access network that IPTV terminals belonging to the IPTV subscription can use.

3. The method of claim 1, further comprising the step of:
d. sending a message to an IPTV control server for informing that the first IPTV service is on.

4. The method of claim 3, wherein the message comprises a Session Initiation Protocol (SIP) PUBLISH message that includes an indication of the selected IPTV service.

5. The method of claim 3, wherein the message comprises a Session Initiation Protocol (SIP) PUBLISH message that includes an indication of a bandwidth consumption related to the IPTV service.

6. An IP Television (IPTV) terminal comprising:
a memory storing bandwidth information regarding an available bandwidth related to an IPTV subscription to which the IPTV terminal belongs;
a processing module in communication with the memory that obtains the information regarding the available bandwidth and determines if the available bandwidth is sufficient for carrying out a selected IPTV service;
an IPTV application module adapted to support IPTV services for the IPTV terminal, the IPTV application module initiating the selected IPTV service when the processing module determines that sufficient bandwidth is available.

7. The IPTV terminal of claim 6, wherein the bandwidth information specifies the total available bandwidth of the access network that IPTV terminals belonging to the IPTV subscription can use.

8. The IPTV terminal of claim 6, further comprising:
an IMS (IP Multimedia Subsystem) stack that sends a message to an IPTV control server for informing that the selected IPTV service is on.

9. The IPTV terminal of claim 8, wherein the message comprises a Session Initiation Protocol (SIP) PUBLISH message that includes an indication of the selected IPTV service.

10. The IPTV terminal of claim 8, wherein the message comprises a Session Initiation Protocol (SIP) PUBLISH message that includes an indication of a bandwidth consumption related to the selected IPTV service.

11. A method for updating one or more IP Television (IPTV) terminals with bandwidth information, the method comprising the steps of:
a. obtaining at an IPTV control server bandwidth information regarding an available bandwidth related to an IPTV subscription to which the one or more IPTV terminals belong; and
b. transmitting from the IPTV control server to each one of the one or more IPTV terminals the bandwidth information.

12. The method of claim 11, wherein step a. comprises the steps of:
a.1. sending a message to a Resource Admission Control Function (RACF) node to request the bandwidth information; and
a.2. receiving from the RACF node the bandwidth information.

13. The method claimed in claim 12, further comprising the step of:
a.3 before step a.1., receiving from an IPTV terminal that belongs to the subscription, a message with an indication that an IPTV service is on;
wherein step a.1. includes sending the message to the RACF with an indication that the IPTV service is on.

14. The method claimed in claim 12, further comprising the step of:
a.3 before step a.1., receiving from an IPTV terminal that belongs to the subscription, a message with an indication that an IPTV service is off;
wherein step a.1. includes sending the message to the RACF with an indication that the IPTV service is off.

15. The method of claim 11, wherein the bandwidth information specifies the total available bandwidth of an access network that the one or more IPTV terminals can use.

16. The method of claim 11, wherein step a. comprises the steps of:
a.1. receiving a message that informs of a bandwidth consumption related to an IPTV service selected by an IPTV terminal of the one or more IPTV terminals that belongs to the IPTV subscription; and
a.2. calculating the bandwidth information using the bandwidth consumption and a bandwidth balance stored in the IPTV control server.

17. An IP Television (IPTV) control server comprising:
a module that obtains bandwidth information regarding an available bandwidth related to an IPTV subscription to which one or more IPTV terminals belong; and
a subscription database that stores IPTV subscription information including the bandwidth information for the IPTV subscription;
wherein the IMS stack transmits to each one of the one or more IPTV terminals the bandwidth information.

18. The IPTV control server of claim 17, wherein the module comprises an IMS (IP Multimedia Subsystem) stack that is further adapted to:
send a message to a Resource Admission Control Function (RACF) node to request the bandwidth information; and
receive from the RACF node the bandwidth information.

19. The IPTV control server claimed in claim 18, wherein the ISM stack is further adapted to receive from an IPTV terminal that belongs to the subscription a message with an indication that an IPTV service is on, wherein the message sent to the RACF includes the indication that the IPTV service is on.

20. The IPTV control server claimed in claim 18, wherein the ISM stack is further adapted to receive from an IPTV terminal that belongs to the subscription a message with an indication that an IPTV service is off, wherein the message sent to the RACF includes the indication that the IPTV service is off.

21. The IPTV control server of claim 17, wherein the bandwidth information specifies the total available bandwidth of an access network that the one or more IPTV terminals can use.

22. The IPTV control server of claim 17, further comprising:
an IP Multimedia Subsystem (IMS) stack adapted to receive a message that informs of a bandwidth consumption related to an IPTV service selected by an IPTV terminal of the one or more IPTV terminals that belongs to the IPTV subscription; and
a processing module that calculates the bandwidth information using the bandwidth consumption and a bandwidth balance stored in the subscription database.
